(19) United States
(12) Patent Application Publication
(10) Pub. No.: US 2015/0068490 A1
(43) Pub. Date: Mar. 12, 2015

(54) MULTI-FUEL ENGINE WITH VARIABLE VALVE TIMING

(71) Applicants: William de Ojeda, Oak Park, IL (US); Ilya Sagalovich, Oakbrook Terrace, IL (US)

(72) Inventors: William de Ojeda, Oak Park, IL (US); Ilya Sagalovich, Oakbrook Terrace, IL (US)

(73) Assignee: International Engine Intellectual Property Company, LLC, Lisle, IL (US)

(21) Appl. No.: 14/373,790

(22) PCT Filed: Jan. 27, 2012
(86) PCT No.: PCT/US12/22857

§ 371 Date: Jul. 22, 2014

(51) Int. Cl. F02D 41/14; F01L 1/34; F02D 41/30; F02D 41/00

(52) U.S. Cl. CPC F02D 41/1498; F02D 41/005; F01L 1/34; F02D 41/3094; F02D 41/3017
USPC 123/27 R

(57) ABSTRACT

In a compression ignition multi-fuel engine employing both port/intake manifold injection of fuel and in-cylinder injection of fuel, the recirculation of exhaust gas to the engine induction system is used to control the temperature and to set the reactivity of an air/fuel charge introduced to the engine for combustion. Fuel directly injected during compression of the charge controls ignition. A variable valve actuator for opening and closing an intake valve extends control over charge pressure and temperature to extend suppression of auto-ignition of the charge. Fuel injection strategy and variable valve actuation are subject to a control strategy to extend the benefits of premixed combustion.

### TECHNICAL FIELD

The disclosure relates to reciprocating internal combustion engines, and in particular relates to compression ignition engines providing concurrent combustion of fuels having differing reactivity indices.

### BACKGROUND

Compression ignition engines, particularly diesel cycle engines, provide power for many trucks and increasing numbers of automobiles throughout the world. The efficiency of diesel engines compares favorably with widely used spark ignition engines, however diesel engines are subject to legal restrictions relating to emissions of nitrous oxide compounds and emissions. The restrictions effect efficiency of operation of the engines.

The four stroke compression ignition engine which has been widely used in motor vehicles works by drawing air into an engine cylinder during a down stroke of the cylinder's piston, compressing the air on a subsequent up/compression stroke of the piston and injecting fuel into the cylinder as or just after the piston reaches the top of its compression stroke. The compression of the air results in increasing air temperature which in turn leads to ignition and combustion of the fuel in the cylinder as the fuel is injected at or near peak cylinder pressure. The combustion of the fuel with oxygen from the air increases pressure in the cylinder and powers the ensuing down or power stroke of the piston. The combustion by-product or exhaust is purged/scavenged from the cylinder during the following up stroke and the cycle repeats. The cylinder is provided with at least one intake valve which opens for the draw stroke and has otherwise been closed and at least one exhaust valve which opens for the exhaust stroke and has otherwise been closed. The coordination of intake and exhaust valve opening have been controlled by a cam shaft and have generally been fixed relative to the stroke position of the piston.

Basic diesel engine operation has been the subject of the application of electronic controls and through modifications of engines. Engine modifications have included: exhaust gas recirculation (EGR); a cooler in the EGR line; hydraulically controlled valve lifters, particularly intake valve lifters, which has allowed varying the timing of valve opening and closing (called variable valve actuation (VVA)) relative to piston position; solenoid control over hydraulic fuel injectors; and turbocharging. Electronic control over these elements in turn permits: selection of the time duration and pressure of fuel injection; varying the number of pulses of fuel injection which occur; varying the timing of injection relative to piston position; varying of the pressure boost to intake air; varying of the engine compression ratios by varying intake valve operation; and varying the temperature of the intake air. The ability to partially control these operational variables in turn increases control over the timing, progression and temperature at which combustion occurs. As a result engine operation can be varied dynamically in response to immediate vehicle conditions.

Concurrent combustion of dual fuels in a compression ignition engine has involved intake port injection of the lower reactivity fuel (e.g. gasoline) and direct in-cylinder injection of high-reactivity fuel (e.g. diesel). The more highly reactive fuel is injected near the top dead center (TDC) position of a piston in its compression stroke resulting in ignition of the more highly reactive fuel followed by combustion of the lower reactivity fuel. In effect the more highly reactive fuel replaces the spark source to ignite the charge, with the benefit that an injected 1 mg quantity of diesel can provide about 40× the energy of a spark promoting faster initiation of combustion. The near TDC piston position for injection of the higher reactivity fuel provides combustion stability yet reduces the effects of the dual fuels on the emission output and the efficiency of the combustion process. Pressure rise rates have been limited by de-rating the engine (lowering the power output) or reducing the compression ratio (depressing efficiency). The flexibility afforded in variable valve actuation and in operation of the fuel injection system allow an integrated control strategy to extend the benefits of fuel reactivity as obtained by high and low reactivity index fuels across an engine load range.

### SUMMARY

An engine system comprises a cylinder having an intake port, an intake valve and an exhaust port, with the cylinder providing for compression of a charge received through the intake valve for combustion in the cylinder. An air induction sub-system coupled to the intake valve supplies air to the engine. A first fuel injector is connected to inject a fuel into the air induction sub-system or the intake port for each charge. An exhaust gas recirculation line connects exhaust gas produced by combustion of a charge and purged through the exhaust port to the air induction sub-system. A recirculated exhaust gas cooler and a valve for controlling recirculation of exhaust gas through the exhaust gas recirculation line and recirculated exhaust gas cooler allows control over dilution and temperature of a charge introduced to a cylinder to suppress auto-ignition of the charge in the cylinder. A second fuel injector injects fuel directly into the cylinder during the compression stroke of the piston for auto ignition. A variable valve actuator for opening and closing the intake valve extends control over charge pressure and temperature to extend suppression of auto-ignition of the charge.

### BRIEF DESCRIPTION OF THE DRAWINGS

FIG. 1 is a general schematic diagram of a multi-fuel motor vehicle engine system.

FIG. 2 is a schematic diagram of a cylinder in the engine system of FIG. 1.

FIG. 3 is a data flow diagram for control over the engine system of FIG. 1.

FIG. 4 is a timing diagram for one cycle of a four stroke reciprocating compression ignition engine with fixed valve timing.

FIG. 5 is a timing diagram for one cycle of a four stroke reciprocating compression ignition engine with variable valve timing.

FIG. 6 illustrates engine torque over engine rpm.

### DETAILED DESCRIPTION

In the following detailed description, like reference numerals and characters may be used to designate identical, corresponding, or similar components in differing drawing figures. Furthermore, example sizes/models/values/ranges may be given with respect to specific embodiments but are not to be considered generally limiting.

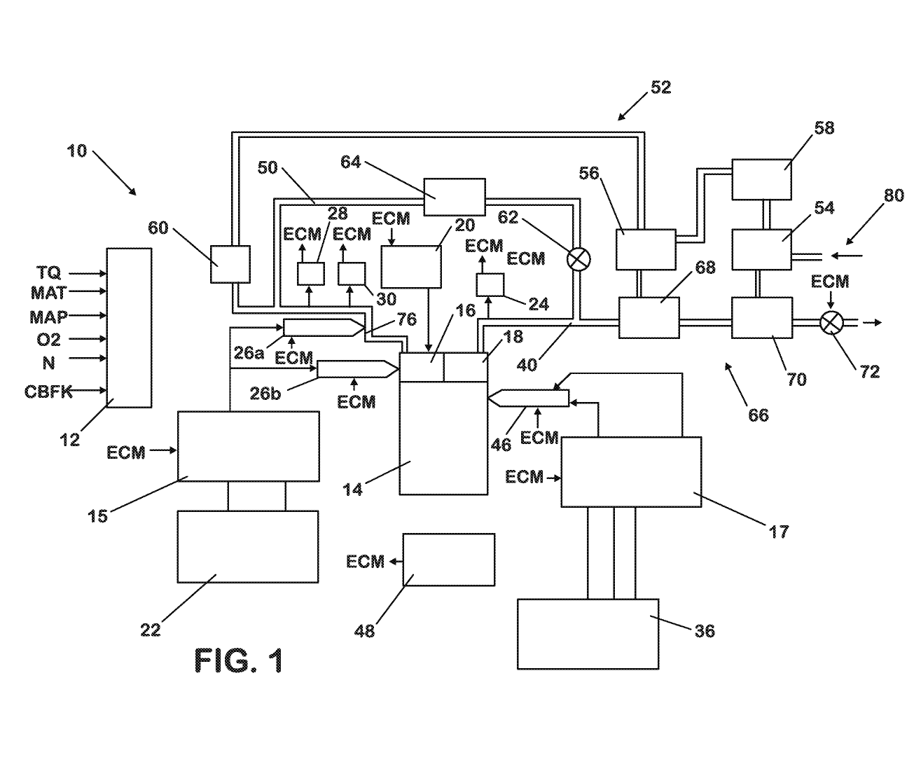

Referring to FIG. 1, a reciprocating engine system 10 supports compression ignition while concurrently burning blends of different fuels each potentially having a different reactivity. Blending is dynamic, and is based on both exogenous inputs and current values for engine operating variables. In a configuration two fuels are burned and may be characterized as “low reactivity” and “high reactivity” fuels. A low pressure fuel injection system 15 draws a low reactivity fuel such as gasoline or natural gas from source 22 and delivers the fuel to a manifold injector 26a or to a port injector 26b for each cylinder. Natural gas is an example of a fuel for which a manifold injector 26a is used while gasoline is an example of a fuel for which a port injector 26b is used. In most applications only one of type of injector location, intake manifold 76 or port 16, is used. The high pressure fuel injection system 17 draws high reactivity fuel from fuel source 36 to supply in-cylinder injectors 46 for each cylinder of engine 14. Diesel grade fuels would be a high reactivity fuel in comparison to natural gas or gasoline.

Air management for engine system 10 is provided through an air induction sub-system 52, an exhaust sub-system 66 and an exhaust gas recirculation (EGR) line 50. The air induction sub-system draws air from the environment and boosts its pressure to support combustion in engine 14. The exhaust sub-system 66 receives combustion by-products from engine 14 and may provide turbines 68, 70 to extract mechanical energy from the combustion by-products before releasing exhaust gas back to the environment after treatment (not shown). The EGR line 50 recirculates a controlled quantity of exhaust gas from the exhaust sub-system 66 back to the air induction sub-system 52 and more particularly to an intake manifold 76.

A turbocharger sub-system 80 provides for extraction of energy from the exhaust sub-system 66 to boost air pressure in the induction sub-system 52 and to retain sufficient backpressure in the exhaust manifold 40 to force recirculated exhaust gas into an intake manifold 76. The turbocharger sub-system 80 comprises a high pressure turbine 68 and a low pressure turbine 70 positioned in series downstream from the exhaust manifold 40 in the exhaust sub-system 66. High pressure turbine 68 is mechanically coupled to drive a high pressure compressor/supercharger 56 and low pressure turbine 70 is mechanically coupled to drive a low pressure compressor/supercharger 54.

The low and high pressure compressors 54, 56 are located connected in series with an intercooler 58 in the air induction sub-system 52. Compressed air from low pressure compressor 54 is directed to high pressure compressor 56 through an intercooler 58 which extracts heat from the intake air and to reduce air temperature. Compressed air from high pressure compressor 56 flows through a high pressure stage cooler 60 into the intake manifold 76 where it is mixed with recirculated exhaust gas. Mechanically or electrically powered superchargers may be substituted for one or both compressors 54, 56 with a loss of energy recapture from the exhaust. Substitution of superchargers allows for simplification of the exhaust sub-system 66 and allows direct control over pressure in the exhaust manifold 40.

Exhaust sub-system 66 carries exhaust from an exhaust port 18 (which includes an exhaust valve) through the high pressure turbine 68 and the low pressure turbine 70. A control valve 72 connects exhaust from the low pressure turbine to the environment. Control valve 72 is used during engine 14 start to force maximum exhaust gas recirculation. The EGR line 50 is connected to the exhaust sub-system 66 upstream from the high pressure turbine 68 and discharges into the intake manifold 76 upstream from the intake port 16 and downstream from the high pressure stage cooler 60. EGR line 50 includes an EGR control valve 62 which controls the portion of exhaust gas from exhaust manifold 40 which is recirculated after engine 14 has warmed to normal operating levels and an EGR cooler 64 for reducing the temperature of the recirculated exhaust gas.

A four cycle combustion process of drawing a charge of air, recirculated exhaust gas and low reactivity fuel, compressing the charge, combustion and purging of exhaust gas is implemented in engine 14 using low reactivity fuel and air introduced through intake port 16 during the intake cycle. High reactivity fuel may be introduced by in-cylinder injector 46 during the piston compression stroke. High reactivity fuel is introduced one or more times near completion of the compression stroke (top dead center or “TDC”) for auto-ignition. The energy released from auto-ignition ignites the low reactivity fuel and remaining high reactivity fuel.

An engine control module (ECM) 12 manages the combustion process in response to engine 14 operating conditions and at least one exogenous variable. Inputs to ECM 12 can come from several sources. An intake manifold 76 pressure sensor 28 reports manifold air pressure (MAP) to ECM 12. An intake manifold 76 air temperature sensor 30 reports manifold air temperature (MAT). An oxygen sensor 24 in the exhaust manifold 40 reports exhaust oxygen levels (O2). Combustion feedback control via in-cylinder combustion phase sensor 48 or physical modeling of the combustion event is used. A combustion phase sensor 48, if present, communicates with the interior of cylinder 14 and provides for detection of ignition and combustion in the cylinder. Presently combustion phase sensor 48 can be a pressure sensor, a knock sensor, or an ion sensor. Data generated by combustion phase sensor 48 is transmitted to ECM 12 as a combustion feedback signal (CBFK). A tachometer (not shown) generates an engine speed signal (N). A torque demand (TQ) signal may be considered as being generated externally. The engine speed signal (N) may and the torque demand signal (TQ) will usually be received by ECM 12 over a network from relatively remote sources. TQ is usually related to an accelerator position signal mediated by a vehicle body computer (not shown). If available an induction air mass sensor may provide a signal as well.

A number of elements of engine system 10 are controlled by ECM 12 to manage engine 14 operation. A variable valve actuator (VVA) 20 controls opening and closing of an intake valve in the intake port 16. VVA 20 allows for varying the timing/phase of opening of the intake valve of intake port 16 relative to piston position. For example, the intake valve may be kept closed for part of the intake stroke which in effect reduces the intake displacement of a cylinder for a given cycle. Variable valve actuation may be extended to the exhaust valve (not shown). Control over either valve can be used to temporarily reduce engine 14 compression.

ECM 12 applies control signals to the low and high pressure fuel injection systems allowing it to set operating pressures. ECM 12 controls the timing, number and duration of injection pulses of fuel by injectors 26a, 26b and, most importantly, injector 46 for each engine 14 cylinder and for each combustion stroke in a cylinder.

Fuel injection is provided both in the induction sub-system 52, usually the intake manifold 76 or intake port 16 using injectors 26a 26b, and directly into the cylinder 14 using injector 46. Metering is provided of both fuel types through port and in-cylinder injection by ECM 12 control signals applied to the low and high pressure fuel injection systems 15, 17 and injectors 26a, 26b and 46. In-cylinder injection pressure levels greater than 300 bar up to systems capable of 3000 bar are provided.

ECM 12 also controls the position of EGR control valve 62 in order to control the proportion of exhaust gas recirculated to the intake manifold 76. This changes the boost provided intake air by compressors 54 and 56. EGR line 50 is capable of recirculating 30% to 60% of exhaust gas to the intake manifold with the percentage being set by control signals applied to control valve 62 by ECM 12. EGR cooler 64 cools the recirculated exhaust gas to a temperature near, but above, the condensation temperature of water.

The multi-turbocharger configuration of turbocharger sub-system 80 (low pressure and high pressure compressors 54, 56) provides delivery of enough oxygen to maintain combustion at lean to stoichiometic levels.

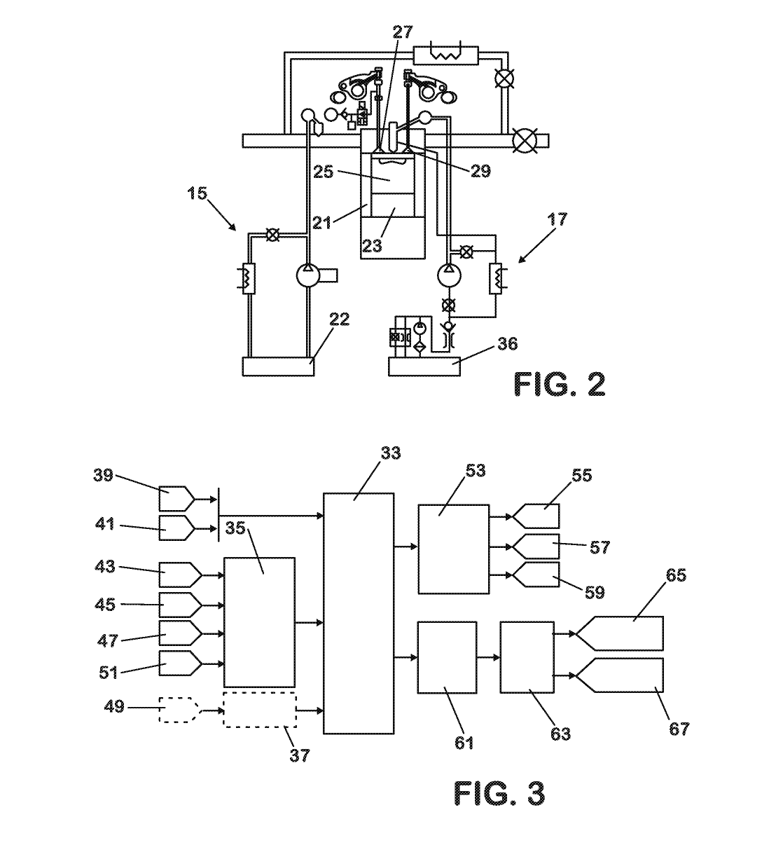

Referring to FIG. 2, a representative cylinder 21 from engine 14 is shown. Cylinder 21 encloses a reciprocating piston 23 which is used to vary the volume of a combustion chamber 25. An intake valve 27 and an exhaust valve 29 may be used to connect the combustion chamber 25 to the intake manifold 76 and to the exhaust manifold 40. Valve 72 in the exhaust manifold 40 represents restrictive features of the exhaust manifold used to generate backpressure which urges some portion of exhaust gas to recirculate to the intake manifold 76 through EGR line 50. A manifold fuel injector 26a provides for injection of low reactivity fuel into the intake manifold 76 and an in-cylinder injector 46 provides for injection of high reactivity fuel directly into combustion chamber 25.

Concurrent combustion of multiple fuels in reciprocating engine 14 is done using a premixed charge air and recirculated exhaust gas with a low reactivity fuel (typically inserted into the port 16 for gasoline like fuels or into the intake manifold 76 for natural gas) and direct injection high-reactivity fuel (typically Diesel) into the combustion cylinder 14. One or more high-reactivity injection events (multiple shots) may be used. The timing of the injection of high-reactivity fuel will range from early in the compression stroke (yielding nearly premixed conditions) to closer to TDC. The combination of dual fuel injection, in-cylinder combustion charge mixture and compression ratio control through variable valve actuation and exhaust gas level, and combustion sensing feedback for combustion adjustments in a cycle-to-cycle basis allows flexibility in adjusting boundary conditions so that the mixture has a reactivity which improves phasing for improved fuel efficiency.

Multiple combustion modes are achieved through specific fuel injection strategies and variable valve actuation control coupled with combustion feedback to expand the robust operating range of premixed combustion. Improved efficiency (approximately 5-10% over current 2010 benchmarks) and the possible elimination NOx after-treatment due to lower operating temperature may be achieved by use of these combustion modes.

In general the injection of a low reactivity fuel and a high-reactivity fuel is distributed between a lower pressure system for port or manifold injection of the low reactivity fuel and high pressure in-cylinder injection for the high reactivity fuel. Recirculated exhaust gas is mixed with induction air and low reactivity fuel charge and the mixture is delivered by port injector 26 to an engine cylinder. Recirculated exhaust gas suppresses auto-ignition of the fuel/gas/air mixture drawn into cylinder 14 before injection of fuel by the high pressure in-cylinder injector 46 at or near TDC of piston 23. The recirculated exhaust gas is cooled and mixed with the air from the induction sub-system 52. The induction air is cooled by high pressure stage cooler 60 and intercooler 58. Manifold temperature of the charge and the degree of dilution of the charge with exhaust gas are targeted to control auto-ignition. The turbo-charger system 80 is a high boost system encompassing multi-stage compressors 54, 56 to provide the sufficient air to run the system lean and above stoichiometric (for efficiency) and provide sufficient pressure to enhance the reactivity of the mixture in the presence of high exhaust gas recirculation rates. The VVA system 20 coupled to the intake port 16 provides further in-cylinder cooling by controlling the compression ratio and for control over charge air-to-fuel ratio and oxygen concentration. One or more high-reactivity injection events (multiple shots) may be used. The timing of the high-reactivity fuel will range from early in the compression stroke (yielding nearly premixed conditions) to closer to TDC. Combustion feedback data is provided either through combustion phase sensing or trough modeling of the combustion phenomenon.

There are several issues to be addressed when mixing two dissimilar fuels with different reactivity indices (such as gasoline's less reactive and Diesel's high reactive quality). The issues are: (1) How to meter and schedule the introduction of fuels in a full engine operating map; (2) Accurately establishing combustion phasing; and (3) Limiting pressure rise rates or knocking. Referring to FIG. 3 a data flow diagram 31 for setting one of two combustion modes in engine system 14. Combustion Mode 1 (CM1) uses the injection timing of the high reactivity fuel to control the combustion phasing. In the event of multiple injections with the injections closer to (or the injection closest to) TDC control(s) the phasing. Combustion Mode 2 (CM2) uses early injection timings (one or multiple shots), and the combustion phasing is controlled by the mass ratio between the low and high reactivity fuels. The more amount of high-reactivity fuel use will move the combustion phasing earlier. CM 2 is highly premixed.

The issue of metering and scheduling the introduction of fuels is addressed by using CM 1 at low loads, where the use of the high-reactivity is necessary to ignite the mixture, switching to CM2 at mid-loads, where the fully premixed characteristics of the charge yields efficiency and emissions and combustion phasing controlled with the reactivity ratio, and reverting to CM1 at high load, where excessive premixed fuel can lead to too high combustion pressure rise rates.

Providing accurate combustion phasing is controlled via injection timing of the high-reactivity fuel (CM1) or by the setting reactivity of the mixture through control of the relative ratio of low to high reactivity fuel (CM2). The ignition delay is modeled according to the reactivity index, temperature and pressure in the manifold (MAT and MAP) and in the cylinder at the time to intake valve closing, the dilution ratio is established by the rates of EGR applied and boost, applying combustion feedback by means of detecting the start of combustion (CBFK). Limiting the high pressure rise rates can be attained by reducing the premix amount of low reactivity fuel, however doing so results in a lowering of engine efficiency and compromises engine 14 emissions. To counteract this effect, or to maintain the high level of premix fuel at high loads, variable valve actuation timing (VVA) in the intake valve 16 (early or late valve closing timing of the intake valve 27 relative to the intake stroke of the piston 23) is used to reduce the effective compression ratio. This application of VVA preserves a cylinder's expansion ratio.

FIG. 3 illustrates the relation of signal inputs to control outputs. The inputs are engine speed (N) 39, torque demand (TQ) 41, (intake) manifold air pressure (MAP) 43, (intake) manifold air pressure (MAP) 45, exhaust oxygen level (O2) 47 and, optionally, a combustion phase feedback value (CBFK) 49. A possible additional input 51, such as mass flow, is reserved. If combustion phasing is determined through a model 35 it is estimated from the values for MAP, MAT and O2. Alternatively combustion phasing may be known directly from CBFK in which case “combustion estimation” is passed through block 37. The combustion estimation value from either block 35 or 37 is passed to a fuel charge system control routine 33. In addition fuel charge system control receives engine speed N and torque demand 41 which indicate the loads imposed on engine 14. The loads are broadly characterized here as “light”, “medium” or “heavy.”

The fuel charge system control block 33 determines the energy output target to be met by the fuel delivered and the oxygen level needed to burn the fuel. These values are passed to a reactivity target block 61 and to the charge air system block 53, respectively. The fuel charge system 33 also selects one of the two combustion modes. Depending upon the combustion mode selected and the load level the charge air system 53 and the reactivity target block 61 establish mixes of recirculated exhaust gas with fresh air to supply and relative quantities of low reactivity and high reactivity fuel to supply. Reactivity of the fuel mix is also dependent upon timing of in-cylinder injection of high reactivity fuel, which is provided for by a fuel module 63. The charge air system 53 applies appropriate control signals relating to turbo boost 55, recirculation of exhaust gas 57 and variable valve actuation timing and duration 59. The fuel module can apply the appropriate fuel injectors for injection low reactivity fuel 65 and high reactivity fuel 67.

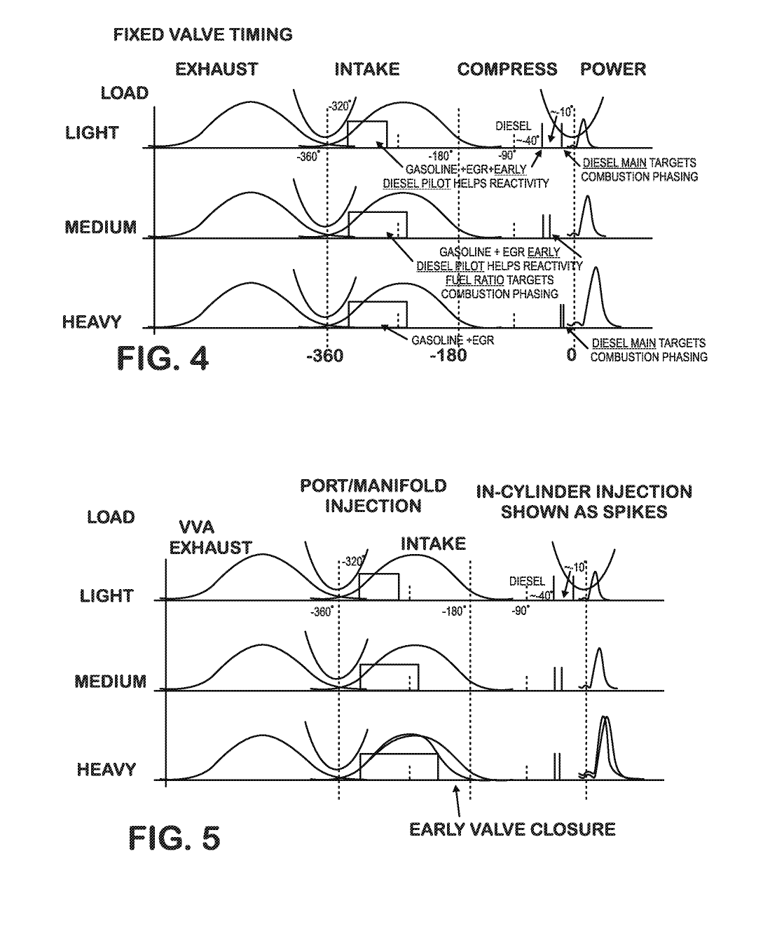

FIGS. 4 and 5 provide a comparison through four cycles of an engine cylinder between operation of a cylinder having fixed valve timing (FIG. 4) and operation of a cylinder with variable valve actuation on the intake valve (FIG. 5). In the example operation is identical for light and medium loads, but for heavy loads the cylinder having VVA for the intake valve closes the intake valve early and uses a higher ratio of low reactivity fuel (gasoline). The combustion modes provide a functional approach to implement dual fuels in a traditional engine with fixed valve timing. The constraints of auto-ignition and excess pressure rise rates limits the application of the low reactivity fuel and directs the switch of combustion modes. This is illustrated in FIG. 4. The addition of VVA allows the extended use of the low-reactivity fuel and effectively extends the use of CM2 to higher loads, retaining the engine efficiency.

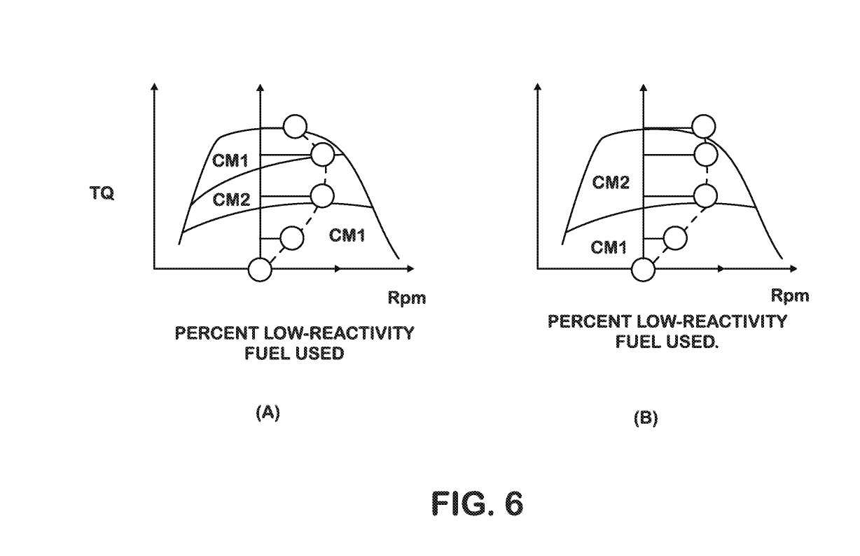

The introduction of two combustion modes to exploit the fuel reactivity properties provided by multi-fuels leads to very low engine our emissions (NOx and PM below the 2010 US regulations) while improving the engine efficiency. The effect of the application of the combustion modes can be extended by use of VVA, which effectively extends the operation of the premix characteristics of what is termed combustion mode 2 allowing retaining high ratios of the low-reactivity fuel as shown in FIG. 6 graph (B) as compared to graph (A).

What is claimed is:

1. An engine system comprising:
a cylinder having an intake port, an intake valve and an exhaust port, with the cylinder providing for compression of a charge received through the intake valve for combustion in the cylinder;
an air induction sub-system coupled to the intake valve;
a first fuel injector connected to inject a fuel into the air induction sub-system or the intake port for each charge;
an exhaust gas recirculation line connecting exhaust gas produced by combustion of a charge and purged through the exhaust port to the air induction sub-system;
a recirculated exhaust gas cooler;
means for controlling recirculation of exhaust gas through the exhaust gas recirculation line and recirculated exhaust gas cooler to provide dilution and temperature control of the charge to suppress auto-ignition of the charge in the cylinder; and
a second fuel injector connected to inject fuel into the cylinder near a level of peak compression for auto ignition and combustion of the charge.

2. An engine system as claimed in claim 1, further comprising:
a variable valve actuator for opening and closing the intake valve to control temperature of the charge undergoing compression to suppress auto-ignition of the charge.

3. An engine system as claimed in claim 3, further comprising:
the first fuel injector being supplied from a source of relatively low reactivity fuel; and
the second fuel injector being supplied from a source of relatively high reactivity fuel.

4. An engine system as claimed in claim 3, the air induction sub-system further comprising:
a low pressure compressor and a high pressure compressor connected in series;
an intercooler coupled between the low pressure and the high pressure compressors; and
a charge air cooler coupled between the high pressure compressor and the intake valve.

5. An engine system as claimed in claim 4, further comprising:
a combustion phase sensor coupled to the cylinder; and
an engine control module coupled to receive combustion phase data from the combustion phase sensor and provide supervisory control over variable valve actuation timing, exhaust gas to charge air mixture ratios and charge air temperature.

6. An engine system as claimed in claim 5, further comprising the low reactivity fuel being gasoline and the high reactivity fuel being diesel.

7. An auto-ignition reciprocating engine system for a vehicle comprising:
an air induction sub-system providing for delivery of air to at least a first cylinder;
a low pressure fuel injector connected to inject a low reactivity fuel into the air induction sub-system;
means for recirculating exhaust gas from the at least first cylinder back to the air induction sub-system;
means for cooling recirculated exhaust gas;
means for controlling the quantity of exhaust gas recirculation to dilute and control the temperature of air in the air induction sub-system to suppress auto-ignition of a charge in the cylinder;
a high pressure fuel injector coupled directly into the cylinder to inject a high reactivity fuel at or near a level of peak compression for auto ignition and thereby to initiate combustion of the charge.

8. An auto-ignition reciprocating engine system as claimed in claim 7, further comprising:
means for variably actuating the intake valve to limit compression and cylinder peak temperature.

9. An auto-ignition reciprocating engine system as claimed in claim 8, further comprising:
means for boosting induction air pressure in the air induction sub-system.

10. A method for operating auto-ignition cycles in a reciprocating engine system, the method comprising the steps of:
delivering air to a combustion chamber for at least a first cylinder;
injecting fuel in the delivered air at low pressure ahead of the combustion chamber;
recirculating exhaust gas into the delivered air;
means for cooling recirculated exhaust gas;
controlling the quantity of exhaust gas recirculation to dilute and controlling the temperature of the delivered air to suppress auto-ignition in the combustion chamber; and
injecting a high reactivity fuel into the cylinder for auto ignition.

11. An auto-ignition reciprocating engine system as claimed in claim 10, comprising the further step of:
variably actuating the intake valve to limit compression and cylinder peak temperature.

12. An auto-ignition reciprocating engine system as claimed in claim 11, comprising the further step of:
boosting pressure of the delivered air.

13. An auto-ignition reciprocating engine as claimed in claim 10, comprising the further step of:
variably actuating the intake valve to control ignition timing.

14. An auto-ignition reciprocating engine as claimed in claim 10, comprising the further step of:
timing direct injections of high reactivity fuel to control ignition timing.

15. An auto-ignition reciprocating engine as claimed in claim 10, comprising the further step of:
responsive to reciprocating engine load and engine speed selecting one of a plurality of combustion modes to improve operating efficiency.
